(19) United States
(12) Patent Application Publication
(10) Pub. No.: US 2011/0116018 A1
(43) Pub. Date: May 19, 2011

(54) LIQUID CRYSTAL DISPLAY ELEMENT

(75) Inventors: Takuto KATO, Kawasaki (JP); Toshiaki Yoshihara, Kawasaki (JP); Yoshihisa Kurosaki, Kawasaki (JP)

(73) Assignee: FUJITSU LIMITED, Kawasaki-shi (JP)

(21) Appl. No.: 12/905,388

(22) Filed: Oct. 15, 2010

(30) Foreign Application Priority Data
Nov. 17, 2009 (JP) 2009-262213

(51) Int. Cl. G02F 1/1347

(52) U.S. Cl. 349/78

(57) ABSTRACT

A liquid crystal display element includes: a first liquid crystal layer including a first liquid crystal, a second liquid crystal and a first electrode; and a second liquid crystal layer including a third liquid crystal, a fourth liquid crystal and a second electrode and laminated with the first liquid crystal layer, wherein the first liquid crystal reflects light in a first wavelength band, the second liquid crystal reflects light in a second wavelength band being different from the first wavelength band and has a threshold voltage for driving being different from that of the first liquid crystal, the third liquid crystal reflects light in the second wavelength band, and the fourth liquid crystal reflects light in a third wavelength band being different from the first wavelength band and the second wavelength band and has a threshold voltage for driving being different from that of the third liquid crystal.

### CROSS-REFERENCE TO RELATED APPLICATIONS

This application is based upon and claims the benefit of priority of the prior Japanese Patent Application No. 2009-262213 filed on Nov. 17, 2009, the entire contents of which are incorporated herein by reference.

### BACKGROUND

1. Field

Embodiments discussed herein relate to a liquid crystal display element (device).

2. Description of Related Art

A liquid crystal display element includes a liquid crystal layer in which liquid crystals are nipped and held between a pair of substrates. A certain drive voltage is applied to the liquid crystal display element, an array of liquid crystal particles in the liquid crystal layer is controlled and external light which is incident upon the liquid crystal display element is modulated, thereby an image is displayed.

Related art is disclosed in Japanese Laid-open Patent Publication No. 2000-267063.

### SUMMARY

According to one aspect of the embodiments, a liquid crystal display element includes: a first liquid crystal layer including a first liquid crystal, a second liquid crystal and a first electrode; and a second liquid crystal layer including a third liquid crystal, a fourth liquid crystal and a second electrode and laminated with the first liquid crystal layer, wherein the first liquid crystal reflects light in a first wavelength band, the second liquid crystal reflects light in a second wavelength band which is different from the first wavelength band and has a threshold voltage for driving which is different from a threshold voltage of the first liquid crystal, the third liquid crystal reflects light in the second wavelength band, and the fourth liquid crystal reflects light in a third wavelength band which is different from the first wavelength band and the second wavelength band and has a threshold voltage for driving which is different from a threshold voltage of the third liquid crystal.

Additional advantages and novel features of the invention will be set forth in part in the description that follows, and in part will become more apparent to those skilled in the art upon examination of the following or upon learning by practice of the invention.

The object and advantages of the invention will be realized and attained by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an exemplary tri-colored liquid crystal display element;

FIG. 2 illustrates an exemplary liquid crystal display element;

FIG. 3 illustrates an exemplary liquid crystal display element;

FIGS. 4A and 4B illustrate an exemplary threshold voltage;

FIG. 5 illustrates an exemplary gradation display;

FIGS. 6A and 6B illustrate an exemplary gradation display;

FIGS. 7A and 7B illustrate an exemplary gradation display;

FIGS. 8A and 8B illustrate an exemplary gradation display;

FIGS. 9A and 9B illustrate an exemplary gradation display;

FIG. 10 illustrates an exemplary gradation display;

FIGS. 11A and 11B illustrate an exemplary gradation display;

FIGS. 12A and 12B illustrate an exemplary gradation display;

FIGS. 13A and 13B illustrate an exemplary gradation display;

FIG. 14 illustrates an exemplary gradation display;

FIGS. 15A and 15B illustrate an exemplary gradation display;

FIGS. 16A and 16B illustrate an exemplary gradation display;

FIGS. 17A and 17B illustrate an exemplary gradation display;

FIG. 18 illustrates an exemplary gradation display; and

FIGS. 19A, 19B, 19C, 19D and 19E illustrate an exemplary panel of a liquid crystal display element.

### DESCRIPTION OF EMBODIMENTS

In a liquid crystal display element including cholesteric liquid crystals, a single panel including liquid crystals of R (Red), G (Green) and B (Blue) color models which reflect light in different wavelength bands are laminated in three layers.

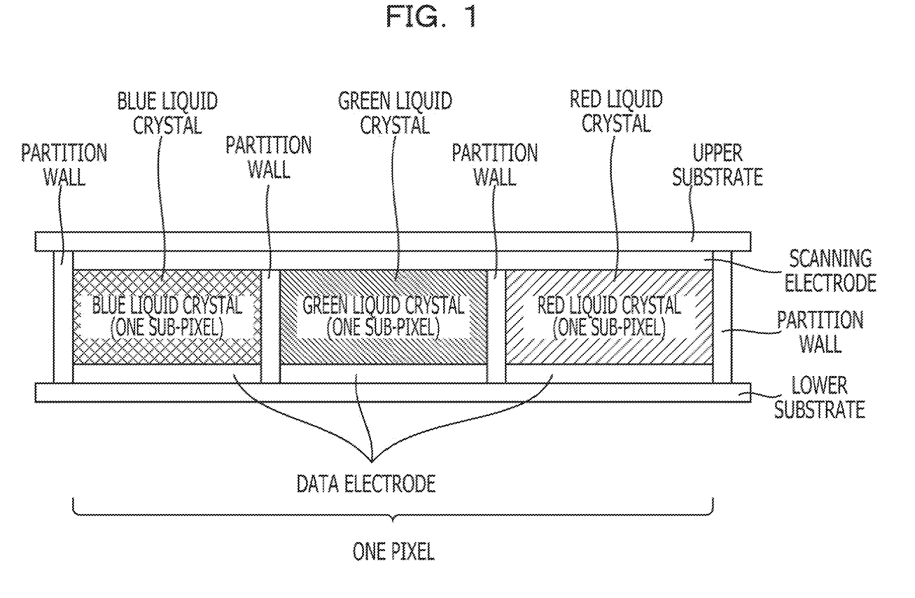

FIG. 1 illustrates an exemplary tri-colored liquid crystal display element. Liquid crystals of three colors of R, G and B are injected into each single panel and one pixel is divided into three sub-pixels. Sub-pixels including liquid crystals of R, G and B color models are set as one pixel. Voltage from each electrode is applied to each of three sub-pixels.

One pixel is divided into three sub-pixels and hence the width of an electrode line is reduced to one-third of the original size. Thus, high-level micromachining may be performed.

In the case that three liquid crystals of R, G and B color models corresponding to sub-pixels are united into one pixel, a seven-colored or eight-colored display of low gradation, which is obtained based on a combination of orientation states of three liquid crystals, for example, a planar state, a focalconic state and a homeotropic state, may be performed.

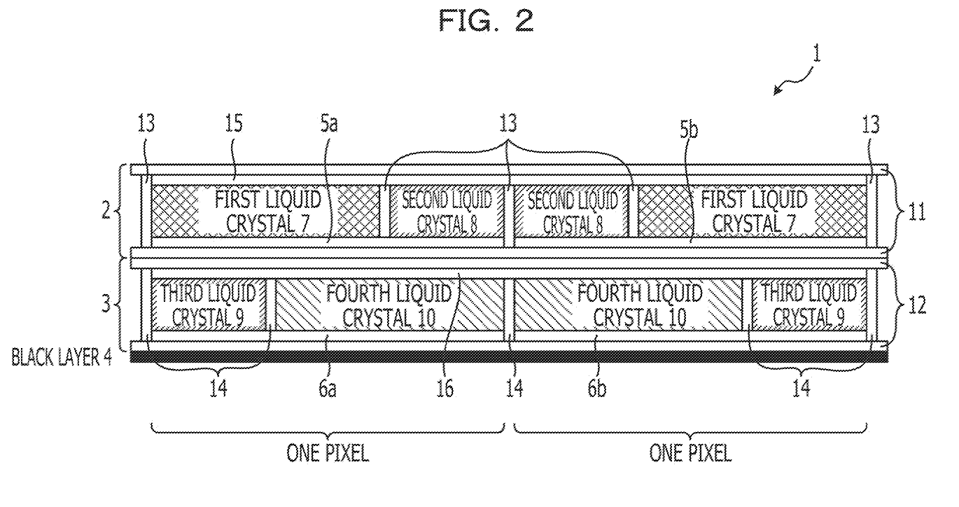

FIG. 2 illustrates an exemplary liquid crystal display element. The liquid crystal display element illustrated in FIG. 2 may include a cholesteric liquid crystal. A liquid crystal display element 1 includes a first liquid crystal layer 2, a second liquid crystal layer 3 and a BK (Black) layer 4. The first liquid crystal layer 2 includes a first liquid crystal 7 and a second liquid crystal 8. The first liquid crystal 7 reflects light in a first wavelength band. The second liquid crystal 8 reflects light in a second wavelength band which is different from the first wavelength band and has a threshold voltage used for driving which is different from that of the first liquid crystal 7. In the first liquid crystal layer 2, the first liquid crystal 7 and the second liquid crystal 8 may be formed in contact with an electrode 5a or an electrode 5b which is disposed for each pixel. The electrode 5a and the electrode 5b may be substantially the same as or similar to each other. In the first liquid crystal layer 2, a partition wall 13 isolates the first liquid crystal 7 from the second liquid crystal 8. The electrode 5a, the electrode 5b, the first liquid crystal 7, the second liquid crystal, the partition wall 13, and a scanning electrode 15 are nipped and held between a pair of substrates 11.

The second liquid crystal layer 3 includes a third liquid crystal 9 and a fourth liquid crystal 10. The third liquid crystal 9 reflects light in the second wavelength band. The fourth liquid crystal 10 reflects light in a third wavelength band which is different from the first wavelength band and the second wavelength band and has a threshold voltage for driving which is different from that of the third liquid crystal 9. In the second liquid crystal layer 3, the third liquid crystal 9 and the fourth liquid crystal 10 may be formed in contact with an electrode 6a or an electrode 6b which is disposed for each pixel. The electrode 6a and the electrode 6b may be substantially the same as or similar to each other. The second liquid crystal layer 3 may be disposed so that the first liquid crystal layer 2 and the second liquid crystal layer 3 are laminated. In the second liquid crystal layer 3, a partition wall 14 isolates the third liquid crystal 9 from the fourth liquid crystal 10. The electrode 6a, the electrode 6b, the third liquid crystal 9, the fourth liquid crystal 10, the partition wall 14 and a scanning electrode 16 are nipped and held between a pair of substrates 12. The second liquid crystal 8 and the third liquid crystal 9 may be liquid crystals which have substantially the same color and reflect light in substantially the same wavelength band.

In the liquid crystal display element 1, for example, voltage is applied to the electrode 5a and the electrode 5b disposed for each pixel and the scanning electrode 15 based on a signal output from a drive circuit (not illustrated) or the like. In the liquid crystal display element 1, voltage is also applied to the electrode 6a and the electrode 6b disposed for each pixel and the scanning electrode 16 based on a signal output from the drive circuit (not illustrated) or the like.

In the liquid crystal display 1, when each liquid crystal is in the planar state, lights directed to the first liquid crystal 7 and the second liquid crystal 8, which have different threshold voltages, and to the third liquid crystal 9 and the fourth liquid crystal 10 which have different threshold voltages, are reflected from the liquid crystals. The light reflected from each liquid crystal is output (displayed) onto a predetermined display screen as a target image. When each liquid crystal is in the focalconic state, light, which is directed to the BK layer 4 corresponding to a visible light absorbing layer, is reflected from the BK layer and the light is output onto the display screen in black. The BK layer 4 may be disposed in accordance with the application of an image to be output onto the display screen.

In the liquid crystal display element 1 which includes the liquid crystals having different threshold voltages, a maximum value, for example, a certain value of brightness of the first liquid crystal 7 is set, and the second liquid crystal 8, the third liquid crystal 9 and the fourth liquid crystal 10 are gradation-displayed, thereby outputting colors of certain patterns. In the liquid crystal display element 1, colors of various patterns may be output based on a combination of gradation-displayed colors of respective liquid crystals.

The liquid crystal display element 1 includes an electrode disposed for each pixel. The liquid crystal display element 1 may include two or more liquid crystal layers. Respective liquid crystal layers reflect light in different wavelength bands and have different threshold voltages for driving. The liquid crystal display element 1 may perform gradation display of high quality with a reduced number of micromachining operations.

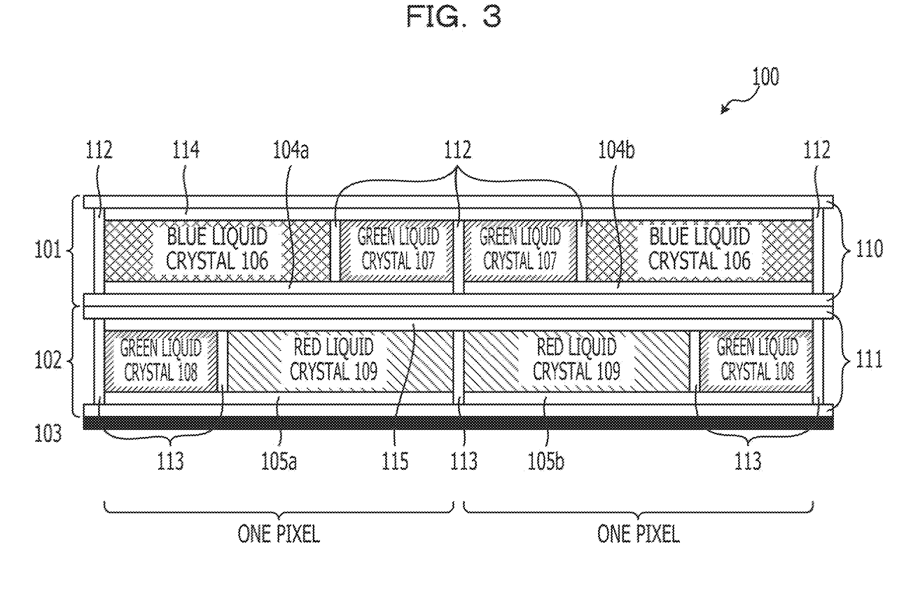

FIG. 3 illustrates an exemplary liquid crystal display element. A liquid crystal display element 100 includes a first liquid crystal layer 101, a second liquid crystal layer 102 and a BK layer 103. The first liquid crystal layer 101 includes a B (Blue) liquid crystal 106 and a G (green) liquid crystal 107. The B liquid crystal 106 reflects light in a first wavelength band. The G liquid crystal 107 reflects light in a second wavelength band which is different from the first wavelength band and has a threshold voltage for driving which is different from that of the B liquid crystal 106.

In the first liquid crystal 101, the B liquid crystal 106 and the G liquid crystal 107 may be formed in contact with substantially the same electrode, for example, an electrode 104a or an electrode 104b which is disposed for each pixel. In the first liquid crystal layer 101, a partition wall 112 isolates the B liquid crystal 106 from the G liquid crystal 107. The electrode 104a, the electrode 104b, the B liquid crystal 106, the G liquid crystal 107, the partition wall 112, and a scanning electrode 114 are nipped and held between a pair of substrates 110.

The first liquid crystal layer 101 may be the first liquid crystal layer 2 illustrated in FIG. 2. The electrode 104a may be the electrode 5a illustrated in FIG. 2. The electrode 104b may be the electrode 5b illustrated in FIG. 2. The B liquid crystal 106 may be the first liquid crystal 7 illustrated in FIG. 2. The G liquid crystal 107 may be the second liquid crystal 8 illustrated in FIG. 2.

The second liquid crystal layer 102 includes a G (Green) liquid crystal 108 and a R (Red) liquid crystal 109. The G liquid crystal 108 reflects light in a second wavelength band. The R liquid crystal 109 reflects light in a third wavelength band which is different from the first wavelength band and the second wavelength band and has a threshold voltage for driving which is different from that of the G liquid crystal 108. In the second liquid crystal layer 102, the G liquid crystal 108 and the R liquid crystal 109 may be formed in contact with an electrode 105a or an electrode 105b which is disposed for pixel. The electrode 105a and the electrode 105b may be substantially the same as or similar to each other. The second liquid crystal layer 102 and the first liquid crystal layer 101 may be laminated.

In the second liquid crystal layer 102, a partition wall 113 isolates the G liquid crystal 108 from the R liquid crystal 109. The electrode 105a, the electrode 105b, the G liquid crystal 108, the R liquid crystal 109, the partition wall 113, and a scanning electrode 115 are nipped and held between a pair of substrates 111. The second liquid crystal layer 102 may be the second liquid crystal layer 3 illustrated in FIG. 2. The electrode 105a may be the electrode 6a illustrated in FIG. 2. The electrode 105b may be the electrode 6b illustrated in FIG. 2. The G liquid crystal 108 may be the third liquid crystal 9 illustrated in FIG. 2. The R liquid crystal 109 may be the fourth liquid crystal 10 illustrated in FIG. 2.

In the liquid crystal display element 100, voltage is applied to the electrode 104a and the electrode 104b, which are disposed for each pixel, and the scanning electrode 114 based on a signal output from a drive circuit (not illustrated) or the like. In the liquid crystal display element 100, voltage is also applied to the electrode 105a and the electrode 105b, which are disposed for each pixel, and the scanning electrode 115 based on a signal output from the drive circuit (not illustrated) or the like.

In the liquid crystal display element 100, when each liquid crystal is in the planar state, lights directed to the B liquid crystal 106 and the G liquid crystal 107, which have different threshold voltages, and to the G liquid crystal 108 and the R liquid crystal 109 which have different threshold voltages, are reflected from the liquid crystals. The light reflected from each liquid crystal is output (displayed) onto a certain display screen as a target image. When each liquid crystal is in the focalconic state, light which is directed to the BK layer 103 corresponding to a visible light absorbing layer is reflected from the BK layer and the light is output onto the display screen in black. The BK layer 103 may be disposed in accordance with the application of an image to be output onto the display screen.

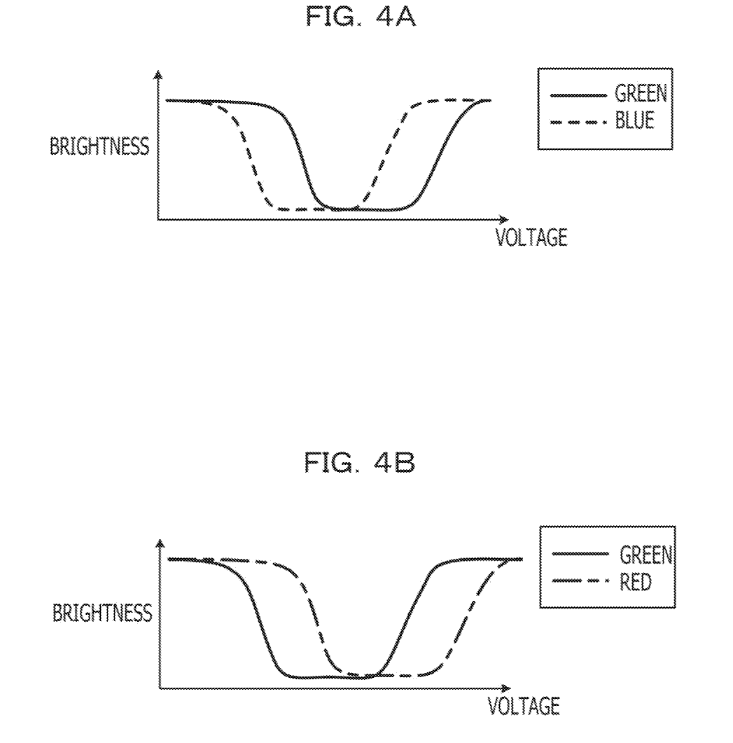

FIG. 4A and FIG. 4B illustrate an exemplary threshold voltage. Each liquid crystal included in the first liquid crystal layer 101 may be driven by the threshold voltage illustrated in FIG. 4A. Each liquid crystal included in the second liquid crystal layer 102 may be driven by the threshold voltage illustrated in FIG. 4B.

For example, the threshold voltage for driving the B liquid crystal 106 included in the first liquid crystal layer 101 may be different from the threshold voltage for driving the G liquid crystal 107 included in the first liquid crystal layer 101. For example, when the thicknesses of the respective liquid crystals are substantially the same as each other, the B liquid crystal 106 and the G liquid crystal 107 may have different threshold voltages because these liquid crystals are anisotropic in terms of dielectric constant. In FIG. 4A, the vertical axis indicates brightness, the horizontal axis indicates voltage, the broken line indicates the threshold voltage and brightness of the B liquid crystal 106 and the solid line indicates the threshold voltage and brightness of the G liquid crystal 107.

The threshold voltage for driving the G liquid crystal 108 included in the second liquid crystal layer 102 may be different from the threshold voltage for driving the R liquid crystal 109 included in the second liquid crystal layer 102. For example, when the thicknesses of the respective liquid crystals are substantially the same as each other, the G liquid crystal 108 and the R liquid crystal 109 may have different threshold voltages because these liquid crystals are anisotropic in terms of dielectric constant. In FIG. 4B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109.

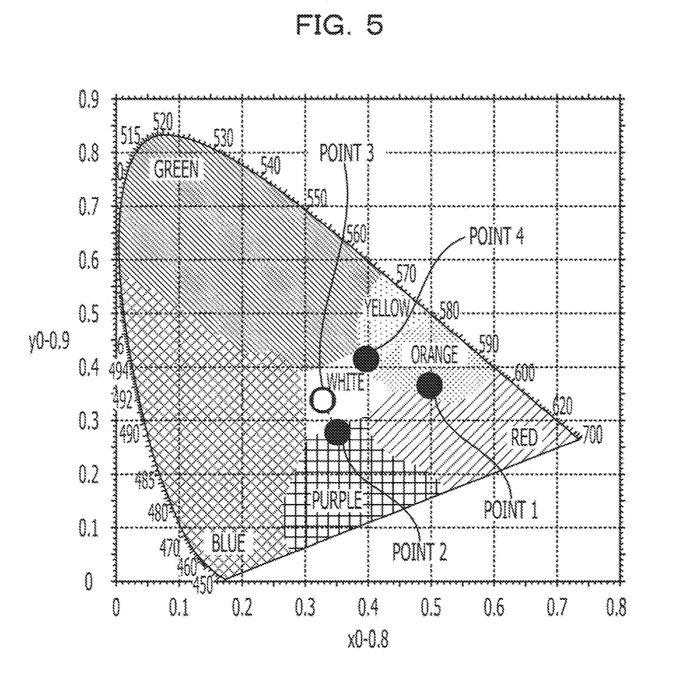

FIG. 5 illustrates an exemplary gradation display. The diagram illustrated in FIG. 5 may be a chromaticity diagram. The chromaticity diagram indicates color tones of white, green, yellow, orange, red, purple, blue and the like. As illustrated in FIG. 5, although it looks as if a boundary is set between adjacent colors, one color may smoothly turn to another color.

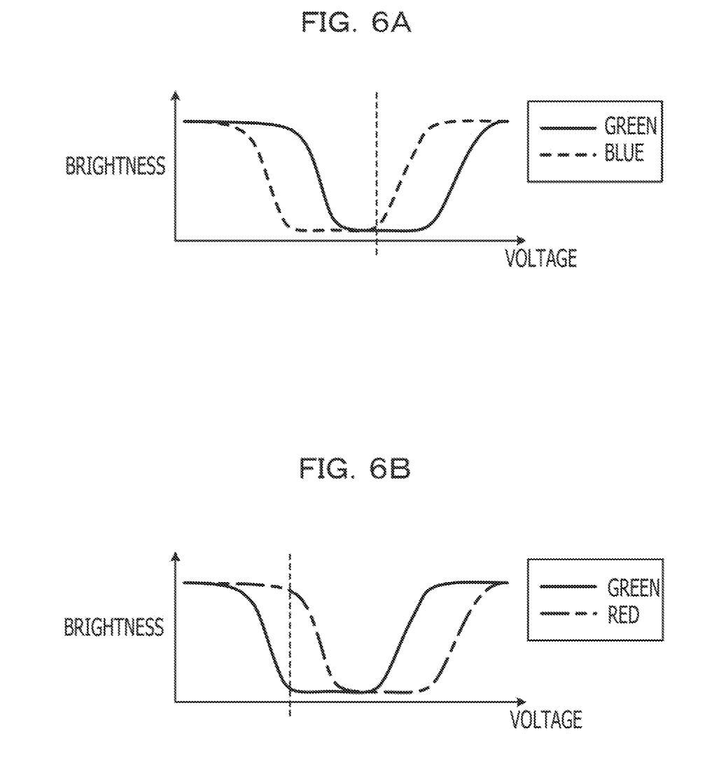

FIG. 6A and FIG. 6B illustrate an exemplary gradation display. The gradation display illustrated in FIG. 6A may be gradation display obtained from the first liquid crystal layer 101 at a point 1 illustrated in FIG. 5. The gradation display illustrated in FIG. 6B may be gradation display obtained from the second liquid crystal layer 102 at the point 1 illustrated in FIG. 5. In FIG. 6A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 6B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 6A and FIG. 6B, the dotted line, which is illustrated in parallel with the vertical line, indicates the position of respective values that each liquid crystal layer uses.

As illustrated in FIG. 6A, in the first liquid crystal layer 101, values of the blue and green liquid crystals which are close to minimum values are utilized. For example, as illustrated in FIG. 6B, in the second liquid crystal layer 102, a value of the green liquid crystal which is close to a minimum value is utilized and a value of the red liquid crystal which is close to a maximum value is utilized. In the gradation display obtained at the point 1, the liquid crystal display element 100 may output a color having high-colored red.

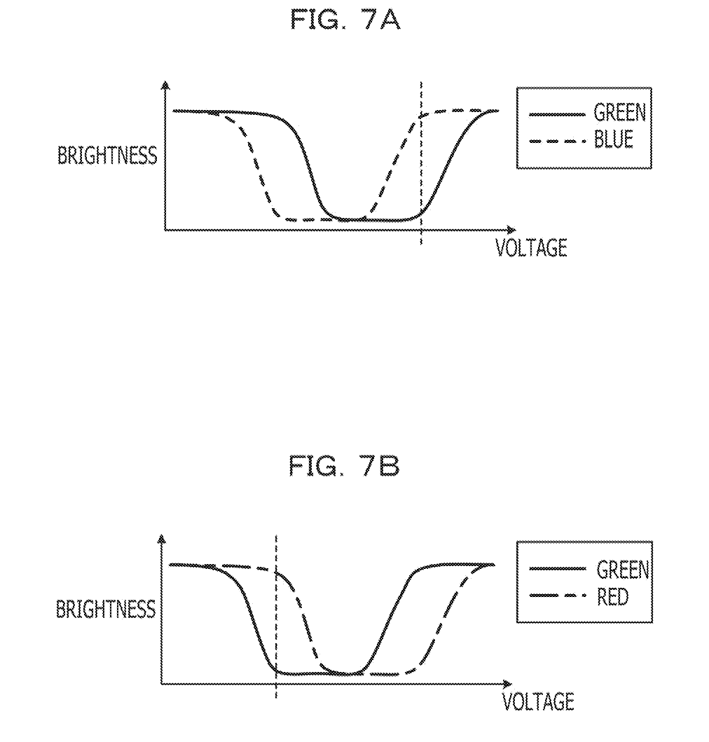

FIG. 7A and FIG. 7B illustrate an exemplary gradation display. The gradation display illustrated in FIG. 7A may be gradation display obtained from the first liquid crystal layer 101 at a point 2 illustrated in FIG. 5. The gradation display illustrated in FIG. 7B may be gradation display obtained from the second liquid crystal layer 102 at the point 2 illustrated in FIG. 5. In FIG. 7A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 7B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 7A and FIG. 7B, the dotted line which is illustrated in parallel with the vertical line indicates the position of respective values that each liquid crystal layer uses.

As illustrated in FIG. 7A, in the first liquid crystal layer 101, a value of the blue liquid crystal which is close to a maximum value is utilized and a value of the green liquid crystal which is close to a minimum value is utilized. For example, as illustrated in FIG. 7B, in the second liquid crystal layer 102, a value of the green liquid crystal which is close a minimum value is utilized and a value of the red liquid crystal which is close to a maximum value is utilized. In the gradation display obtained at the point 2, the liquid crystal display element 100 may output a purplish color having high-colored red and high-colored blue.

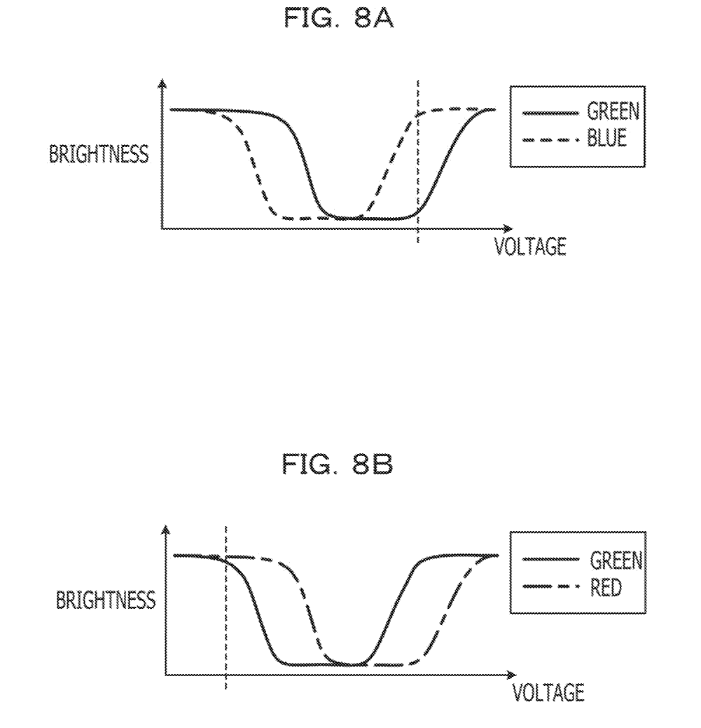

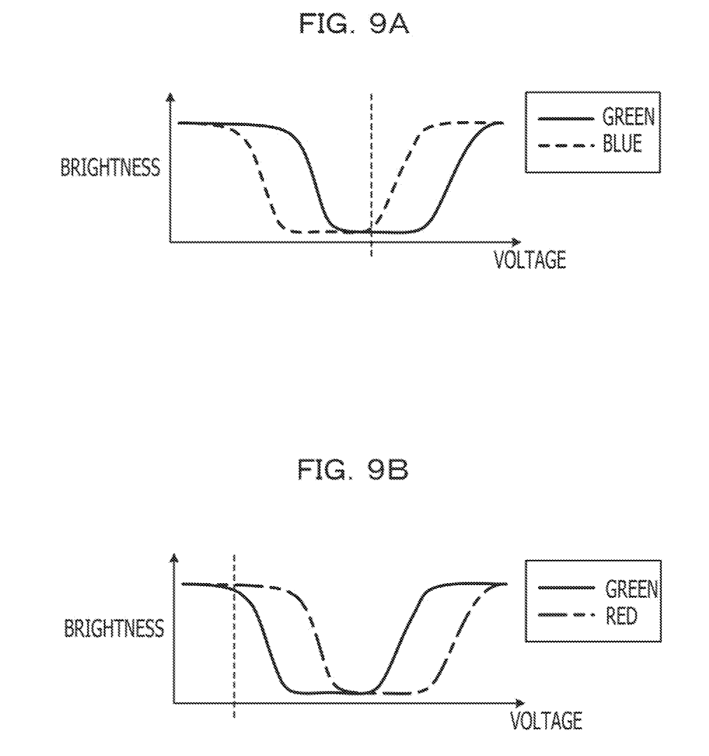

FIG. 8A and FIG. 8B illustrate an exemplary gradation display. The gradation display illustrated in FIG. 8A may be gradation display obtained from the first liquid crystal layer 101 at a point 3 illustrated in FIG. 5. The gradation display illustrated in FIG. 8B may be gradation display obtained from the second liquid crystal layer 102 at the point 3 illustrated in FIG. 5. In FIG. 8A, the vertical axis indicates brightness, the horizontal axis indicates voltage, the broken line indicates the threshold voltage and brightness of the B liquid crystal layer 106 and the solid line indicates the threshold voltage and brightness of the G liquid crystal 107. In FIG. 8B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 8A and FIG. 8B, the dotted line which is illustrated in parallel with the vertical line indicates the position that each liquid crystal layer uses.

For example, as illustrated in FIG. 8A, in the first liquid crystal layer 101, a value of the blue liquid crystal which is close to a maximum value is utilized and a value of the green liquid crystal which is close to a minimum value is utilized. For example, as illustrated in FIG. 8B, in the second liquid crystal layer 102, values of the green and red liquid crystals which are respectively close to maximum values are utilized. In the gradation display obtained at the point 3, the liquid crystal display element 100 may output white from the color tones of blue, green and red.

FIG. 9A and FIG. 9B illustrate an exemplary gradation display. The gradation display illustrated in FIG. 9A may be gradation display obtained from the first liquid crystal layer 101 at a point 4 illustrated in FIG. 5. The gradation display illustrated in FIG. 9B may be gradation display obtained from the second liquid crystal layer 102 at the point 4 illustrated in FIG. 5. In FIG. 9A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 9B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 9A and FIG. 9B, the dotted line which is illustrated in parallel with the vertical line indicates the position that each liquid crystal layer uses.

For example, as illustrated in FIG. 9A, in the first liquid crystal layer 101, values of the blue and green liquid crystals which are respectively close to minimum values are utilized. For example, as illustrated in FIG. 9B, in the second liquid crystal layer 102, values of the green and red liquid crystals which are respectively close to maximum values are utilized. In the gradation display obtained at the point 4, the liquid crystal display element 100 may output a yellowish color having high-colored green and high-colored red.

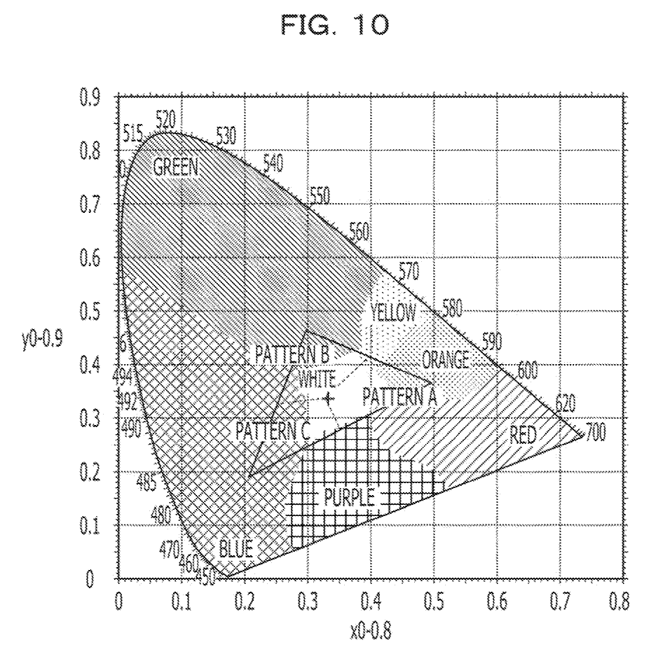

FIG. 10 illustrates an exemplary gradation display. The gradation display illustrated in FIG. 10 may be a chromaticity diagram. For example, the chromaticity diagram indicates the color tones of white, green, yellow, orange, red, purple, blue and the like. In the example illustrated in FIG. 10, although it looks as if a boundary is set between adjacent colors, one color may smoothly turn to another color.

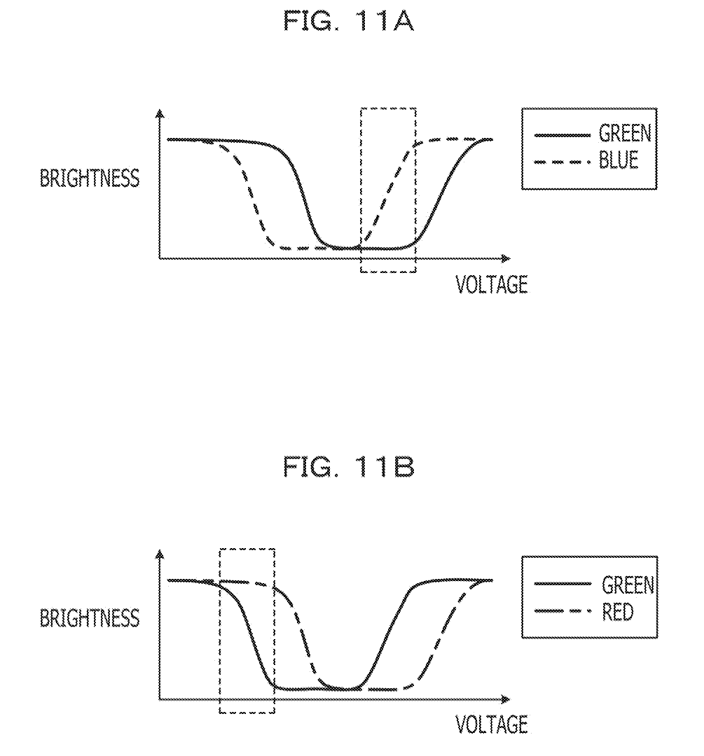

FIG. 11A and FIG. 11B illustrate an exemplary gradation display. The gradation display illustrated in FIG. 11A may be the gradation display at a pattern A of the first liquid crystal layer 101 illustrated in FIG. 3. The gradation display illustrated in FIG. 11B may be the gradation display at the pattern A of the second liquid crystal layer 102 illustrated in FIG. 3. In FIG. 11A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 11B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 11A and FIG. 11B, a dotted-line area which is illustrated in parallel with the vertical line indicates the area that each liquid crystal layer uses.

For example, as illustrated in FIG. 11A, in the first liquid crystal layer 101, regarding the blue color, a value, which ranges from a value that is close to a minimum value to a value that is close to a maximum value in the dotted-line area, is utilized. Regarding the green color, a value, which is close to a minimum value in the dotted-line area, is utilized. For example, as illustrated in FIG. 11B, in the second liquid crystal layer 102, regarding the green color, a value, which ranges values of the green liquid crystal ranging from a value that is close to a maximum value to a value that is close to a minimum value in the dotted-line area, is utilized. Regarding the red color, a value, which is close to a maximum value in the dotted-line area, is utilized. In the gradation display of the pattern A, the liquid crystal display element 100 may output a color which is output as the dotted-line areas illustrated in FIG. 11A and FIG. 11B move, for example, a color of gradation which is included in an area surrounded by white, yellow, orange, red and purple areas.

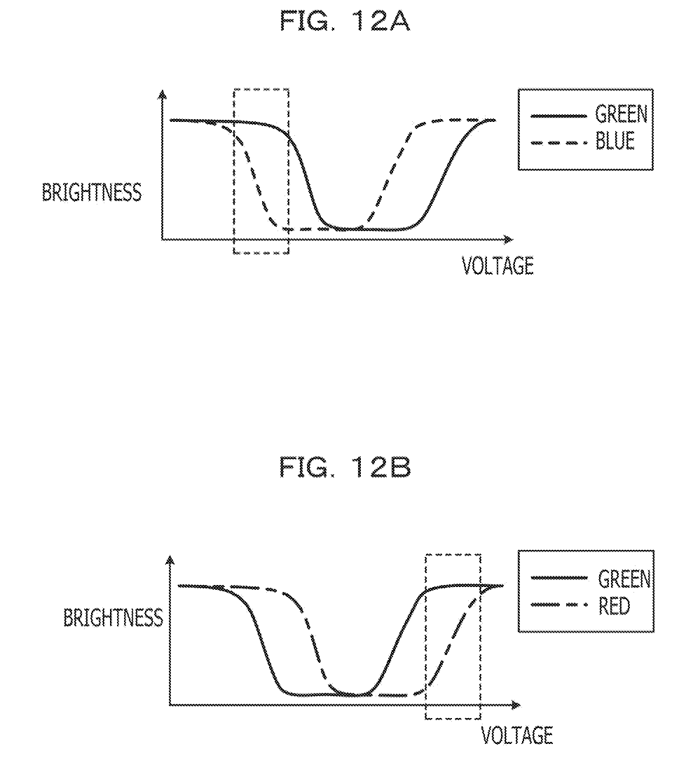

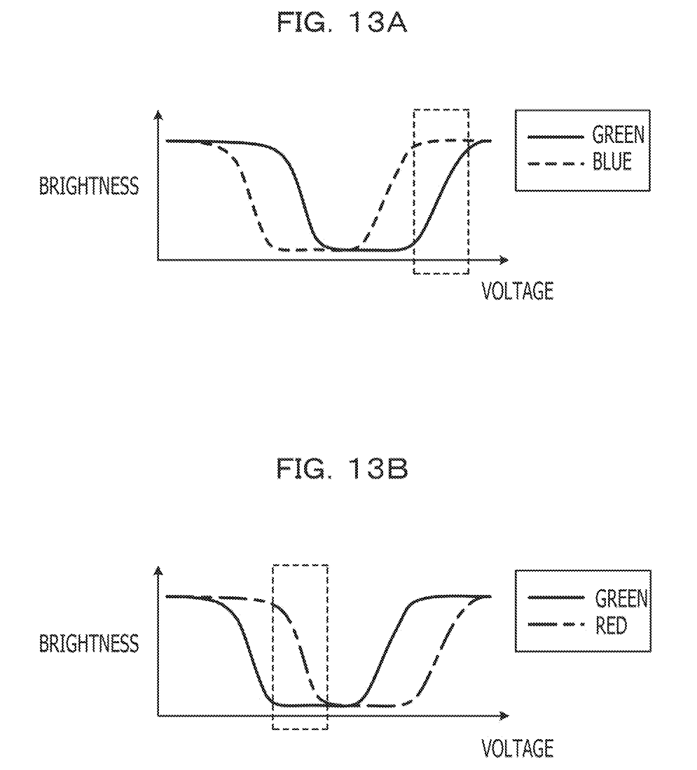

FIG. 12A and FIG. 12B illustrate an exemplary gradation display. The gradation display illustrated in FIG. 12A may be the gradation display at a pattern B of the first liquid crystal layer 101 illustrated in FIG. 3. The gradation display illustrated in FIG. 12B may be the gradation display at the pattern B of the second liquid crystal layer 102 illustrated in FIG. 3. In FIG. 12A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 12B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 12A and FIG. 12B, a dotted-line area which is illustrated in parallel with the vertical line indicates the area that each liquid crystal layer uses.

For example, as illustrated in FIG. 12A, in the first liquid crystal layer 101, regarding the blue color, a value, which ranges from a value that is close to a maximum value to a value that is close to a minimum value in the dotted-line area, is utilized. Regarding the green color, a value, which is close to a maximum value in the dotted-line area, is utilized. For example, as illustrated in FIG. 12B, in the second liquid crystal layer 102, regarding the green color, a value, which is close to a maximum value in the dotted-line area, is utilized. Regarding the red color, a value, which ranges from a value that is close to a minimum value to a value that is close to a maximum value in the dotted-line area, is utilized. In the gradation display of the pattern B, the liquid crystal display element 100 may output a color which is output as the dotted-line areas illustrated in FIG. 12A and FIG. 12B move, for example, a color of gradation which is included in an area surrounded by white, blue-green neutral tint, green and yellow areas.

FIG. 13A and FIG. 13B illustrate an exemplary gradation display. The gradation display illustrated in FIG. 13A may be the gradation display at a pattern C of the first liquid crystal layer 101 illustrated in FIG. 3. The gradation display illustrated in FIG. 13B may be the gradation display at the pattern C of the second liquid crystal layer 102 illustrated in FIG. 3. In FIG. 13A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 13B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 13A and FIG. 13B, a dotted-line area which is illustrated in parallel with the vertical line indicates the area that each liquid crystal layer uses.

For example, as illustrated in FIG. 13A, in the first liquid crystal layer 101, regarding the blue color, a value which is close to a maximum value in the dotted-line area, is utilized. Regarding green color, a value, which ranges from a value which is close to a minimum value to a value which is close to a maximum value in the dotted-line area, is utilized. For example, as illustrated in FIG. 13B, in the second liquid crystal layer 102, regarding the green color, a value, which is close to a minimum value in the dotted-line area, is utilized. Regarding the red color, a value, which ranges from a value which is close to a maximum value to a value which is close to a minimum value in the dotted-line area, is utilized. In the gradation display at the pattern C, the liquid crystal display element 100 may output a color which is output as the dotted-line areas illustrated in FIG. 13A and FIG. 13B move, for example, a color of gradation which is included in an area surrounded by white, blue-green neutral tint, blue and purple areas.

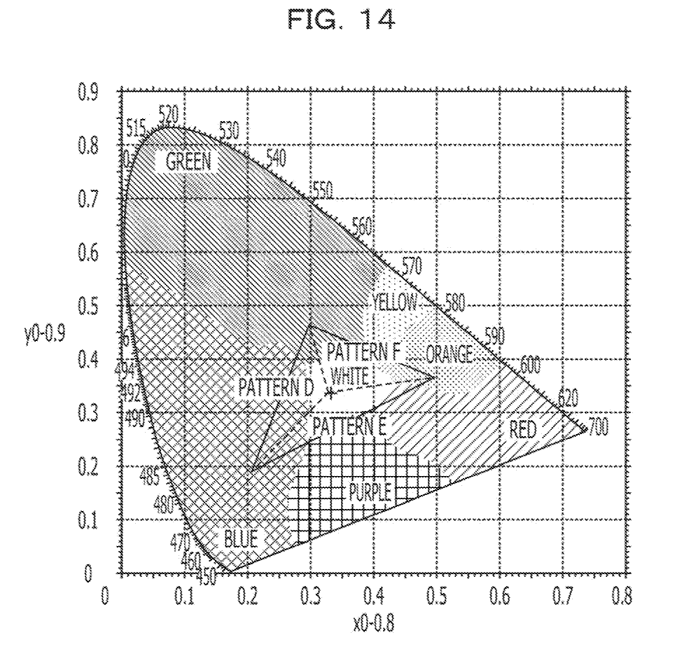

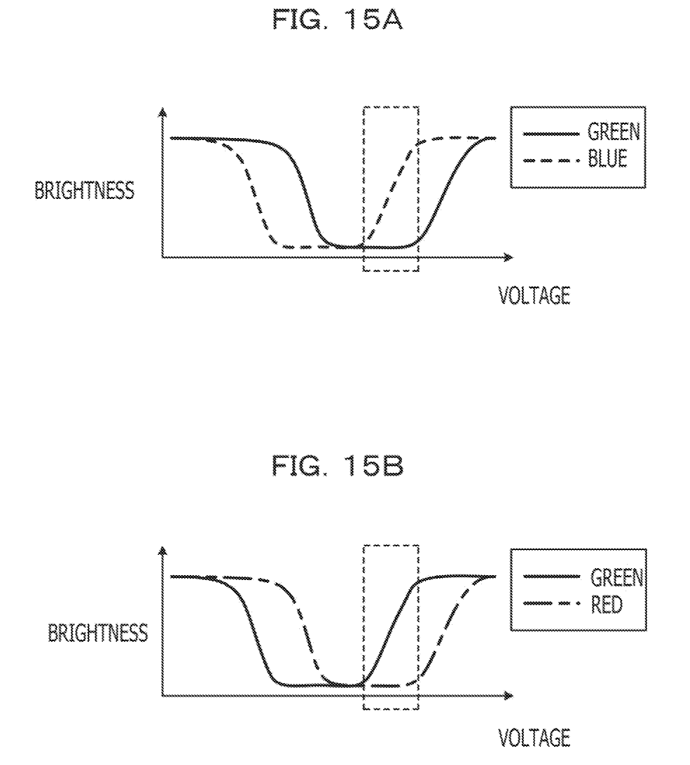

FIG. 14 illustrates an exemplary gradation display. The gradation display illustrated in FIG. 14 may be a chromaticity diagram. For example, the chromaticity diagram indicates the color tones of white, green, yellow, orange, red, purple, blue and the like. In the example illustrated in FIG. 14, although it looks as if a boundary is set between adjacent colors, one color may smoothly turn to another color.

FIG. 15A and FIG. 15B illustrate an exemplary gradation display. The gradation display illustrated in FIG. 15A may be the gradation display at a pattern D of the first liquid crystal layer 101 illustrated in FIG. 3. The gradation display illustrated in FIG. 15B may be the gradation display at the pattern D of the second liquid crystal layer 102 illustrated in FIG. 3. In FIG. 15A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 15B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 15A and FIG. 15B, a dotted-line area which is illustrated in parallel with the vertical line indicates the area that each liquid crystal layer uses.

For example, as illustrated in FIG. 15A, in the first liquid crystal layer 101, regarding the blue color, a value, which ranges from a value that is close to a minimum value to a value that is close to a maximum value in the dotted-line area, is utilized. Regarding the green color, a value, which is close to a minimum value in the dotted-line area, is utilized. For example, as illustrated in FIG. 15B, in the second liquid crystal layer 102, regarding the green color, a value, which ranges from a value that is close to a minimum value to a value that is close to a maximum value in the dotted-line area, is utilized. Regarding the red color, a value, which is close to a minimum value in the dotted-line area, is utilized. In the gradation display of the pattern D, the liquid crystal display element 100 may output a color which is output as the dotted-line areas illustrated in FIG. 15A and FIG. 15B move, for example, a color of gradation which is included in an area surrounded by white, blue and green areas.

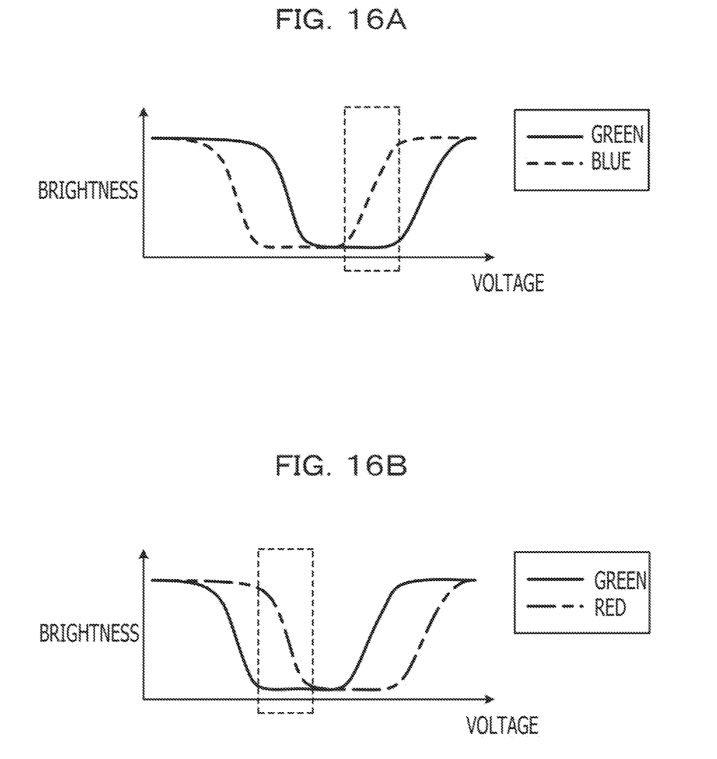

FIG. 16A and FIG. 16B illustrate an exemplary gradation display. The gradation display illustrated in FIG. 16A may be the gradation display at a pattern E of the first liquid crystal layer 101 illustrated in FIG. 3. The gradation display illustrated in FIG. 16B may be the gradation display at the pattern E of the second liquid crystal layer 102 illustrated in FIG. 3. In FIG. 16A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 16B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 16A and FIG. 16B, a dotted-line area which is illustrated in parallel with the vertical line indicates the area that each liquid crystal layer uses.

For example, as illustrated in FIG. 16A, in the first liquid crystal layer 101, regarding the blue color, a value, which ranges from a value that is close to a minimum value to a value that is close to a maximum value in the dotted-line area, is utilized. Regarding the green color, a value, which is close to a minimum value in the dotted-line area, is utilized. For example, as illustrated in FIG. 16B, in the second liquid crystal layer 102, regarding the green color, a value, which is close to a minimum value in the dotted-line area, is utilized. Regarding the red color, a value, which ranges from a value that is close to a maximum value to a value that is close to a minimum value in the dotted-line area, is utilized. In the gradation display of the pattern E, the liquid crystal display element 100 may output a color which is output as the dotted-line areas illustrated in FIG. 16A and FIG. 16B move, for example, a color of gradation which is included in an area surrounded by white, blue, purple, red and orange areas.

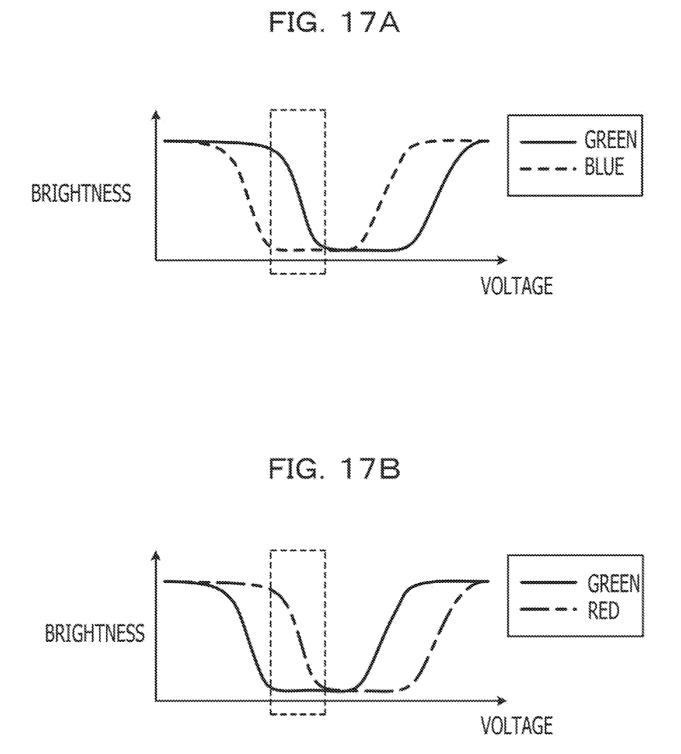

FIG. 17A and FIG. 17B illustrate an exemplary gradation display. The gradation display illustrated in FIG. 17A may be the gradation display at a pattern F of the first liquid crystal layer 101 illustrated in FIG. 3. The gradation display illustrated in FIG. 17B may be the gradation display at the pattern F of the second liquid crystal layer 102 illustrated in FIG. 3. In FIG. 17A, the vertical axis indicates brightness, the horizontal axis indicates voltage, the broken line indicates the threshold voltage and brightness of the B liquid crystal 106 and the solid line indicates the threshold voltage and brightness of the G liquid crystal 107. In FIG. 17B, the vertical axis indicates brightness, the horizontal axis indicates voltage, the solid line indicates the threshold voltage and brightness of the G liquid crystal 108 and the one-dot broken line indicates the threshold voltage and brightness of the R liquid crystal 109. In each of FIG. 17A and FIG. 17B, a dotted-line area which is illustrated in parallel with the vertical line indicates the area that each liquid crystal layer uses.

For example, as illustrated in FIG. 17A, in the first liquid crystal layer 101, regarding the blue color, a value, which is close to a minimum value in the dotted-line area, is utilized. Regarding the green color, a value, which ranges from a value that is close to a maximum value to a value that is close to a minimum value in the dotted-line area, is utilized. For example, as illustrated in FIG. 17B, in the second liquid crystal layer 102, regarding the green color, a value, which is close to a minimum value in the dotted-line area, is utilized. Regarding the red color, a value, which ranges from a value that is close to a maximum value to a value that is close to a minimum value in the dotted-line area, is utilized. In the gradation display of the pattern F, the liquid crystal display element 100 may output a color which is output as the dotted-line areas illustrated in FIG. 17A and FIG. 17B move, for example, a color of gradation which is included in an area surrounded by white, orange, yellow and green areas.

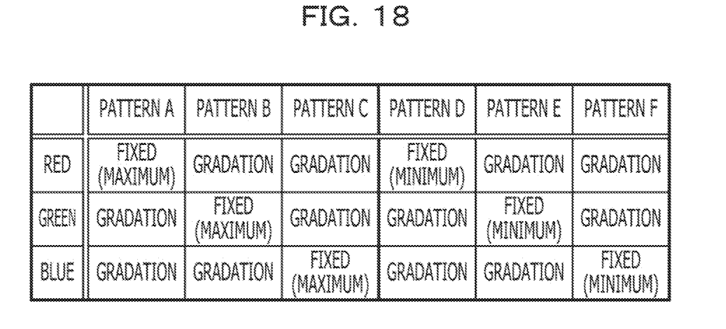

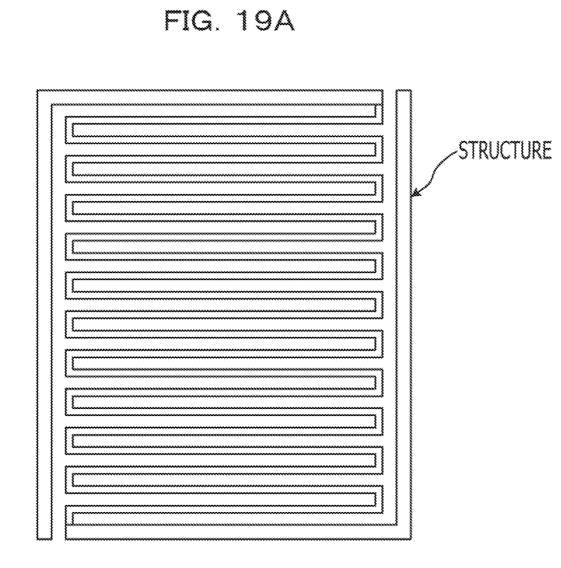

FIG. 18 is a diagram illustrating an exemplary gradation display. In the gradation of the pattern A illustrated in FIG. 10, for example, regarding the red color, a value reaches the vicinity of a maximum value, the value of the green color varies in a certain area and the value of the blue color varies in a certain area. In the gradation of the pattern B illustrated in FIG. 10, for example, the value of the red liquid crystal varies in a predetermined area, the value of the green liquid crystal reaches the vicinity of a maximum value and the value of the blue liquid crystal varies in a predetermined area. In the gradation of the pattern C illustrated in FIG. 10, for example, the value of the red color varies in a certain area, the value of the green color varies in a certain area and the value of the blue color reaches the vicinity of a maximum value.

In the gradation of the pattern D illustrated in FIG. 14, for example, the value of the red color reaches the vicinity of a minimum value, the value of the green color varies in a certain area and the value of the blue color varies in a certain area. In the gradation of the pattern E illustrated in FIG. 14, for example, the value of the red color varies in a certain area, the value of the green color reaches the vicinity of a minimum value and the value of the blue color varies in a certain area. In the gradation of the pattern F illustrated in FIG. 14, for example, the value of the red color varies in a certain area, the value of the green color varies in a certain area and the value of the blue color reaches the vicinity of a minimum value.

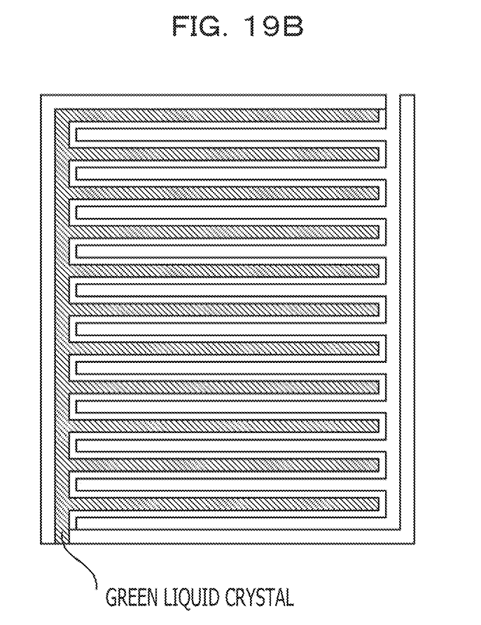

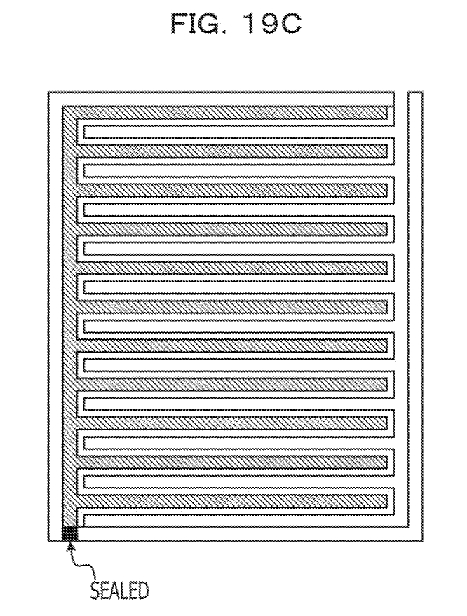

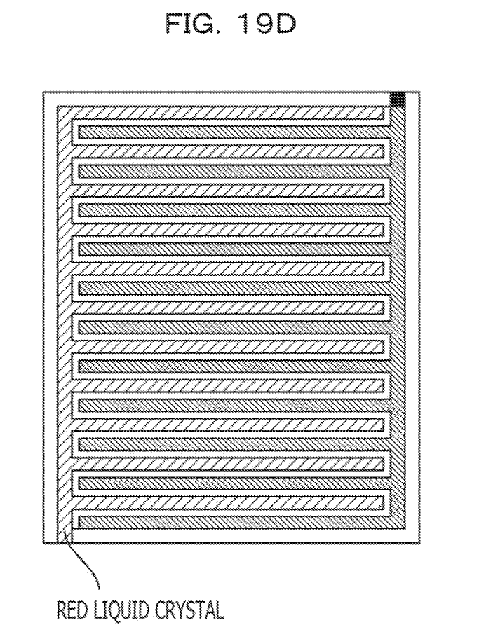

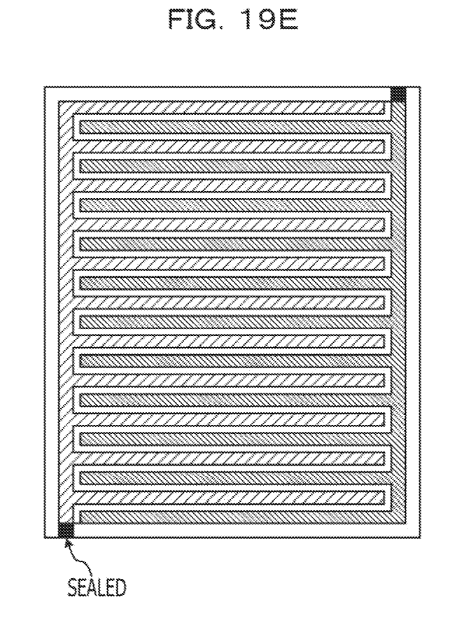

FIG. 19A to FIG. 19E illustrate an exemplary a panel of a liquid crystal display element. The panel illustrated in FIG. 19A to FIG. 19E may be a panel used in the liquid crystal display element 100 illustrated in FIG. 3. FIG. 19A illustrates an exemplary structure corresponding to an empty panel before liquid crystals are injected. In FIG. 19B, the green liquid crystal is injected into the structure. In FIG. 19C, a port through which the green liquid crystal is injected is sealed. In FIG. 19D, the red liquid crystal is injected into the structure. In FIG. 19E, a port through which the red liquid crystal is injected is sealed. A combination of the red liquid crystal and the green liquid crystal and a combination of the blue liquid crystal and the green liquid crystal may be respectively injected into the respective liquid crystal layers of the liquid crystal display element 100.

For example, the substrate may be a 100 μm-thick film substrate made of polyethylene terephthalate. A transparent conductive film is deposited onto a surface of the substrate. Drive electrodes are formed on two substrates so as to direct orthogonally to each other for passive driving. The liquid crystal display element 100 includes four substrates, for example two sets of substrates.

An acrylic negative resist is deposited on one substrate of the two substrates using a spinner and photo-processing is performed on the substrate. The structure includes an acrylic negative resist used to define a liquid crystal injection region which is partitioned into two parts. A sealant is applied to one substrate in order to form two openings through which liquid crystals are injected in end parts of the substrate. The two substrates are put together and pressed and heated to be adhered to each other.

For example, two structures or empty panels as illustrated in FIG. 19A are respectively evacuated. Each of the structures is dipped in a green cholesteric liquid crystal and then exposed to atmospheric pressure. As a result, the green liquid crystal is injected into the structure as illustrated in FIG. 19B. Then, as illustrated in FIG. 19C, a port through which the green liquid crystal has been injected into the structure is sealed. Then, a red liquid crystal is injected into the structure as illustrated in FIG. 19D. Then, a port through which the red liquid crystal has been injected into the structure is sealed as illustrated in FIG. 19E.

A method of forming a liquid crystal layer into which blue and green liquid crystals are injected may be substantially the same as or similar to a method of forming a liquid crystal layer into which green and red liquid crystals are injected. After each of the liquid crystal layers (liquid crystal panels) is formed, a panel including the blue and green liquid crystals and a panel including the red and green liquid crystals are laminated in this order in two layers from a direction in which light is reflected to form a liquid crystal panel. The liquid panel is anisotropicin terms of dielectric constant. The red and green liquid crystals which have different threshold voltage for driving are injected and the blue and green liquid crystals which have different threshold voltage for driving are also injected.

The liquid crystal display element 100 drives liquid crystals of different wavelength bands using a common electrode which is disposed for each pixel. The liquid crystal display element 100 includes two liquid crystal layers, each including a plurality of liquid crystals having different threshold voltages, and performs gradation display by combining driving patterns of the respective liquid crystals. The liquid crystal display element 100 performs gradation display with high quality without high-level micromachining. The liquid crystal display element 100 has a two-layered structure and hence the number of lines of electrodes may be reduced and the number of drivers for applying voltages to respective electrodes may be reduced, thereby reducing the cost involved.

In order to make different threshold voltages for liquid crystals, an orientation film may be disposed at a boundary between each liquid crystal and each electrode.

For example, the first liquid crystal layer 101 may include orientation films which are interposed between the B liquid crystal 106 and the electrode 104a and between the G liquid crystal 107 and the electrode 104b. For example, the second liquid crystal layer 102 may include orientation films which are interposed between the G liquid crystal 108 and the electrode 105a and between the R liquid crystal 109 and the electrode 105b.

In order to make different threshold voltages for liquid crystals, orientation films having different film thicknesses respectively may be disposed at boundaries between one liquid crystal and one electrode and between another liquid crystal and another electrode.

For example, the first liquid crystal layer 11 may include orientation films having different film thicknesses which are interposed between the B liquid crystal 106 and the electrode 104a and between the G liquid crystal 107 and the electrode 104b. For example, the second liquid crystal layer 102 may include orientation films having different film thicknesses which are interposed between the G liquid crystal 108 and the electrode 105a and between the R liquid crystal 109 and the electrode 105b.

For example, a panel of the liquid crystal display element 100 having orientation films of different film thicknesses includes, for example, a 100 μm-thick film substrate made of polyethylene terephthalate. A transparent conductive film is deposited onto a surface of the substrate. Two substrates include drive electrodes which are formed orthogonally to each other for passive driving. The liquid crystal display element 100 includes four substrates (two sets of substrates).

In order to make different threshold voltages for driving for different regions in which respective liquid crystals are formed in a single panel of each substrate, orientation films having different film thicknesses are formed. For example, an Ultraviolet (UV) curable liquid crystal is applied using a spinner. A region in which one liquid crystal is formed is UV-cured and cleaned and one orientation film is formed in the region in which the one liquid crystal is formed. The UV-curable liquid crystal is applied using a spinner by changing the rotation frequency of the spinner and a region in which the other liquid crystal is formed is UV-cured and cleaned and the other orientation film having a film thickness, which is different from that of the one orientation film in the region in which the one liquid crystal is formed, is formed in the region in which the other liquid crystal is formed.

An acrylic negative resist is deposited onto one substrate using a spinner and photo-processing is performed on the substrate. The structure includes an acrylic negative resist used to define a liquid-crystal-injected region which is partitioned into two parts. A sealant is applied to one substrate in order to form two openings through which the liquid crystals are injected in end parts of the substrate. Two substrates are put together and pressed and heated to be adhered to each other.

Two structures corresponding to empty panels as illustrated in FIG. 19A are respectively evacuated. As illustrated in FIG. 19B, each of the structures is dipped in a green cholesteric liquid crystal and then is exposed to atmospheric pressure. As a result, the green liquid crystal is injected into the structure as illustrated in FIG. 19B. Then, as illustrated in FIG. 19C, a port through which the green liquid crystal has been injected into the structure is sealed. Then, a red liquid crystal is injected into the structure as illustrated in FIG. 19D. Then, a port through which the red liquid crystal has been injected into the structure is sealed as illustrated in FIG. 19E.

A method of forming a liquid crystal layer into which blue and green liquid crystals are injected may be substantially the same as or similar to a method of forming a liquid crystal layer into which green and red liquid crystals are injected. After the respective liquid crystal layers, for example, liquid crystal panels are formed, a panel including the blue and green liquid crystals and a panel including the red and green liquid crystals are laminated in this order in two layers from a direction in which light is reflected. Since orientation films having different film thicknesses respectively are formed, the red and green liquid crystals having different threshold voltages for driving and the blue and green liquid crystals having different threshold voltages for driving are respectively injected into the panels. The orientation film may include a film made of a UV curable liquid crystal or a film having effect to control orientation.

Colors of liquid crystals injected into each panel may be arbitrarily combined with each other.

In order to make different threshold voltages for driving liquid crystals, the viscosities of respective liquid crystals may be changed.

For example, a substrate which is different from a film substrate such as a glass substrate or the like may be used. The film substrate may include a film substrate made of a material other than polyethylene terephthalate.

A negative resist or a positive resist other than an acrylic resist may be deposited onto a substrate. When the positive resist is used, a spherical spacer such as a resinous spacer may be sprayed onto a substrate.

Example embodiments have now been described in accordance with the above advantages. It will be appreciated that these examples are merely illustrative of the invention. Many variations and modifications will be apparent to those skilled in the art.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

1. A liquid crystal display element comprising:
a first liquid crystal layer including a first liquid crystal, a second liquid crystal and a first electrode; and
a second liquid crystal layer including a third liquid crystal, a fourth liquid crystal and a second electrode and laminated with the first liquid crystal layer,
wherein the first liquid crystal reflects light in a first wavelength band,
the second liquid crystal reflects light in a second wavelength band which is different from the first wavelength band and has a threshold voltage for driving which is different from a threshold voltage of the first liquid crystal,
the third liquid crystal reflects light in the second wavelength band, and
the fourth liquid crystal reflects light in a third wavelength band which is different from the first wavelength band and the second wavelength band and has a threshold voltage for driving which is different from a threshold voltage of the third liquid crystal.

2. The liquid crystal display element according to claim 1, wherein
the first liquid crystal and the second liquid crystal are anisotropic in terms of dielectric constant and are in contact with the first electrode disposed for each pixel, and
wherein the third liquid crystal and the fourth liquid crystal are anisotropic in terms of dielectric constant and are in contact with the second electrode disposed for each pixel.

3. The liquid crystal display element according to claim 1, further comprising:
first orientation films disposed between the first liquid crystal and the first electrode and between the second liquid crystal and the first electrode; and
second orientation films disposed between the third liquid crystal and the second electrode and between the fourth liquid crystal and the second electrode.

4. The liquid crystal display element according to claim 1, further comprising:
a first orientation film disposed between the first liquid crystal and the first electrode;
a second orientation film disposed between the second liquid crystal and the first electrode and having a different film thickness from a film thickness of first orientation film;
a third orientation film disposed between the third liquid crystal and the second electrode; and
a fourth orientation film disposed between the fourth liquid crystal and the second electrode and having a different film thickness from a film thickness of the third orientation film.
